(19) United States
(12) Patent Application Publication
(10) Pub. No.: US 2019/0089218 A1
(43) Pub. Date: Mar. 21, 2019

(54) STATOR AND ROTARY ELECTRIC MACHINE

(71) Applicant: HONDA MOTOR CO., LTD., Tokyo (JP)

(72) Inventors: Keisuke Azusawa, Wako-shi (JP); Tadao Nishiyama, Wako-shi (JP); Ryotaro Kaneko, Wako-shi (JP); Yasushi Noguchi, Wako-shi (JP)

(21) Appl. No.: 16/129,893

(22) Filed: Sep. 13, 2018

(30) Foreign Application Priority Data
Sep. 15, 2017 (JP) 2017-177851

(51) Int. Cl. H02K 3/34; H02K 3/12; H02K 3/28; H02K 15/02; B32B 27/28

(52) U.S. Cl. CPC H02K 3/34; H02K 3/12; H02K 2203/06; H02K 15/024; B32B 27/281; H02K 3/28

(57) ABSTRACT

A stator includes a stator core provided with a slot, and a conductive wire disposed in the slot. The conductive wire has a rectangular conductor, and a coating film coated on a surface of the rectangular conductor, a varnish configured to fix a surface of the coating film and an inner surface of the slot is filled between the surface of the coating film and the inner surface of the slot, and the surface of the coating is provided with a recessed part-forming region in which a recessed part into which the varnish enters is formed.

### CROSS-REFERENCE TO RELATED APPLICATION

Priority is claimed on Japanese Patent Application No. 2017-177851, filed Sep. 15, 2017, the content of which is incorporated herein by reference.

### BACKGROUND OF THE INVENTION

### Field of the Invention

The present invention relates to a stator and a rotary electric machine.

### Description of Related Art

Rotary electric machines used as power sources for hybrid vehicles or electric vehicles are required to be small in size and high in power.

In the related art, in order to respond to such demands, a structure in which conductive wires are arranged side by side in a slot of a stator core has been proposed (for example, refer to Japanese Patent No. 5981089 (hereinafter referred to as Patent Document 1)).

The stator of Patent Document 1 includes a stator core and a conductive wire. The stator core has a slot. The conductive wire is arranged in the slot. The conductive wire has a rectangular conductor and a coating film. The coating film is formed of, for example, a resin material, and is coated on a surface of the rectangular conductor. A varnish is filled between the coating film of the conductive wire and the slot. The varnish has insulating properties and fixes the conductive wire to the stator core.

### SUMMARY OF THE INVENTION

In the stator of Patent Document 1, the conductive wire is fixed to the stator core by filling the varnish between the surface of the coating film and an inner surface of the slot. However, depending on the variation of the filling amount of the varnish, the conductive wire may not be reliably fixed to the stator core. It is also conceivable to control the filling amount of the varnish and completely fill the varnish between the surface of the coating film and the inner surface of the slot. However, considering variations in a clearance between the surface of the coating film and the inner surface of the slot, it is difficult to completely fill the varnish by controlling the filling amount of the varnish. Therefore, there is room for further improvement in that the conductive wire is easily and reliably fixed to the stator core.

In view of the above circumstances, an aspect of the present invention is to provide a stator capable of easily and reliably fixing a conductive wire to a stator core, and a rotary electric machine including the stator.

In order to solve the above problem and achieve the object, the present invention adopts the following mode.

(1) A stator according to an aspect of the present invention is a stator including a stator core provided with a slot, and a conductive wire disposed in the slot, wherein the conductive wire has a rectangular conductor, and a coating film coated on a surface of the rectangular conductor, a varnish configured to fix a surface of the coating film and an inner surface of the slot is filled between the surface of the coating film and the inner surface of the slot, and the surface of the coating is provided with a recessed part-forming region in which a recessed part into which the varnish enters is formed.

(2) In the above aspect (1), the depth of the recessed part may be set to 1 μm or more and 10 μm or less.

(3) In the above aspect (1) or (2), the recessed part of the recessed part-forming region may be formed by being processed with sand blasting.

(4) In any one of the above aspects (1) to (3), a plurality of recessed part-forming members may be provided in the recessed part-forming region, and the recessed part may be formed between the plurality of recessed part-forming members.

(5) In the above aspect (4), the plurality of recessed part-forming members may be formed in a particle shape.

(6) In the above aspect (5), wherein the plurality of recessed part-forming members may be hollow.

(7) A rotary electric machine according to an aspect of the present invention includes the stator of any one of the above aspects (1) to (6).

In the above aspect (1), the recessed part-forming region is provided in the surface of the coating film of the conductive wire.

Since this increases a surface area of the coating film, the adhesiveness of the varnish to the surface of the coating film is improved. Furthermore, since the varnish enters the recessed part, an anchoring effect can be obtained. Therefore, the varnish can reliably fix the surface of the coating film and the inner surface of the slot.

Therefore, in the above aspect (1), it is possible to reliably fix the conductive wire to the stator core, merely by providing the recessed part-forming region in the surface of the coating film of the conductive wire.

Therefore, in the above aspect (1), the conductive wire can be easily and reliably fixed to the stator core.

In the above aspect (2), the depth of the recessed part is set to 1 μm or more and 10 μm or less.

As a result, since the varnish can sufficiently enter the recessed part, it is possible to further reliably fix the surface of the coating film and the inner surface of the slot.

Therefore, in the above aspect (2), it is possible to further reliably fix the conductive wire to the stator core.

Further, in the above aspect (2), by setting the depth of the recessed part to 1 μm or more and 10 μm or less, it is possible to suppress a decrease in the partial discharge starting voltage and to prevent partial discharge.

In the above aspect (3), the recessed part in the recessed part-forming region is formed by processing with sand blasting.

As a result, it is possible to easily form the recessed part. Therefore, the varnish can more easily fix the surface of the coating film and the inner surface of the slot. Further, depending on the particle diameter used in the sand blasting, the size of the recessed part can be easily adjusted to form the recessed part.

Therefore, the above aspect (3), it is possible to easily and reliably fix the conductive wire to the stator core.

In the above aspect (4), a plurality of recessed part-forming members are provided in the recessed part-forming region, and the recessed part is formed between the plurality of recessed part-forming members.

Thus, it is possible to easily adjust the size of the recessed part and form the recessed part, merely by adjusting the ratio between the materials for forming the coating film and the recessed part-forming member, the size of the recessed part-forming member and the like. Therefore, the varnish can more easily fix the surface of the coating film and the inner surface of the slot.

Therefore, in the above aspect (4), it is possible to easily and reliably fix the conductive wire to the stator core.

In the above aspect (5), each of the plurality of recessed part-forming members is formed in a particle shape.

Thus, it is possible to easily to adjust the size of the recessed part and form the recessed part, by merely adjusting the ratio between the materials for forming the coating film and the recessed part-forming member or the particle size of the recessed part-forming member. Therefore, the varnish can more easily fix the surface of the coating film and the inner surface of the slot.

Therefore, in the above aspect (5), it is possible to easily and reliably fix the conductive wire to the stator core.

In the above aspect (6), the recessed part-forming member is formed in a particulate and hollow shape.

As a result, it is possible to easily form the recessed part by suppressing an increase in the dielectric constant. Therefore, the varnish can suppress partial discharge and easily fix the surface of the coating film and the inner surface of the slot.

Therefore, in the above aspect (6), it is possible to suppress partial discharge and easily and reliably fix the conductive wire to the stator core.

In the above aspect (7), the rotary electric machine includes the above-mentioned stator capable of easily and reliably fixing the conductive wire to the stator core.

Therefore, it is possible to provide a high-performance rotary electric machine having excellent durability.

### BRIEF DESCRIPTION OF THE DRAWINGS

FIG. 1 is a cross-sectional view illustrating an overall configuration of an electric motor including a stator according to a first embodiment.

FIG. 2 is a cross-sectional view of part of the stator.

FIG. 3 is an enlarged view of a part A of FIG. 2.

FIG. 4 is an enlarged view of a part B of FIG. 3.

FIG. 5 is a cross-sectional view of a conductive wire of a stator according to a second embodiment.

FIG. 6 is a cross-sectional view of a conductive wire of a stator according to a modified example of the second embodiment.

### DETAILED DESCRIPTION OF THE INVENTION

Hereinafter, each embodiment of the present invention will be described with reference to the drawings.

### First Embodiment

A stator 5 of the first embodiment will be described.

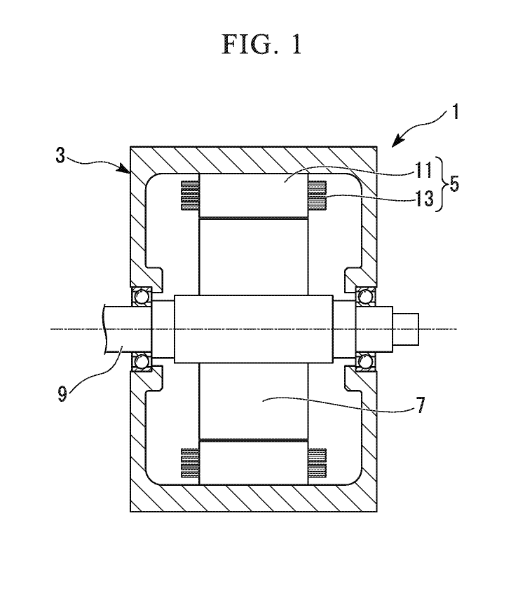

FIG. 1 is a cross-sectional view illustrating an overall configuration of an electric motor including the stator of the first embodiment.

As illustrated in FIG. 1, an electric motor 1 (corresponding to a “rotary electric machine” in the claims) according to the embodiment includes a case 3, a stator 5, a rotor 7, and an output shaft 9.

The electric motor 1 of the present embodiment is, for example, a running motor mounted in a vehicle such as a hybrid car or an electric car. However, the configuration of the present embodiment is not limited to the above example and can also be applied to a motor for other purposes such as a power generation motor mounted in a vehicle. Further, the configuration of the present embodiment is a rotary electric machine other than the one mounted in a vehicle, and is applicable to all kinds of so-called rotary electric machines including a generator.

The case 3 is, for example, formed in a tubular shape which accommodates the stator 5 and the rotor 7.

The stator 5 is annularly formed and attached, for example, to an inner peripheral surface of the case 3. The stator 5 has a stator core 11 and a winding 13 attached to the stator core 11, and applies a rotating magnetic field to the rotor 7.

The rotor 7 has, for example, a rotor core and a magnet attached to the rotor core, and is rotationally driven inside the stator 5. The output shaft 9 is connected to the rotor 7 and outputs the rotation of the rotor 7 as a driving force.

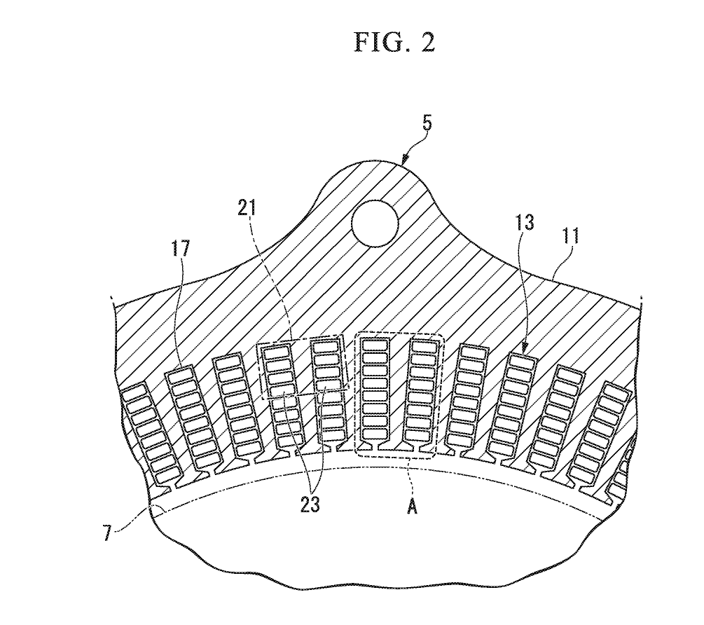

FIG. 2 is a cross-sectional view illustrating part of the stator.

As illustrated in FIG. 2, the stator 5 includes a stator core 11 and a winding 13.

The stator core 11 is formed in an annular shape which surrounds the rotor 7. The stator core 11 is provided with a plurality of slots 17. A plurality of slots 17 are arranged side by side in a circumferential direction of the stator core 11. The slots 17 pass through the stator core 11 in an axial direction of the stator core 11. The cross section of the slots 17 is formed in a rectangular shape.

The winding 13 is accommodated in the plurality of slots 17 and mounted in the stator core 11. The winding 13 is a three-phase coil including a U-phase, a V-phase and a W-phase. The winding 13 of the present embodiment is formed by a plurality of segment coils 21 connected to each other and used.

One segment coil 21 includes a plurality (for example, four) of conductive wires 23. Each of the conductive wires 23 is inserted and disposed in the slots 17 and 17 adjacent to each other in the circumferential direction. The respective conductive wires 23 are connected to each other.

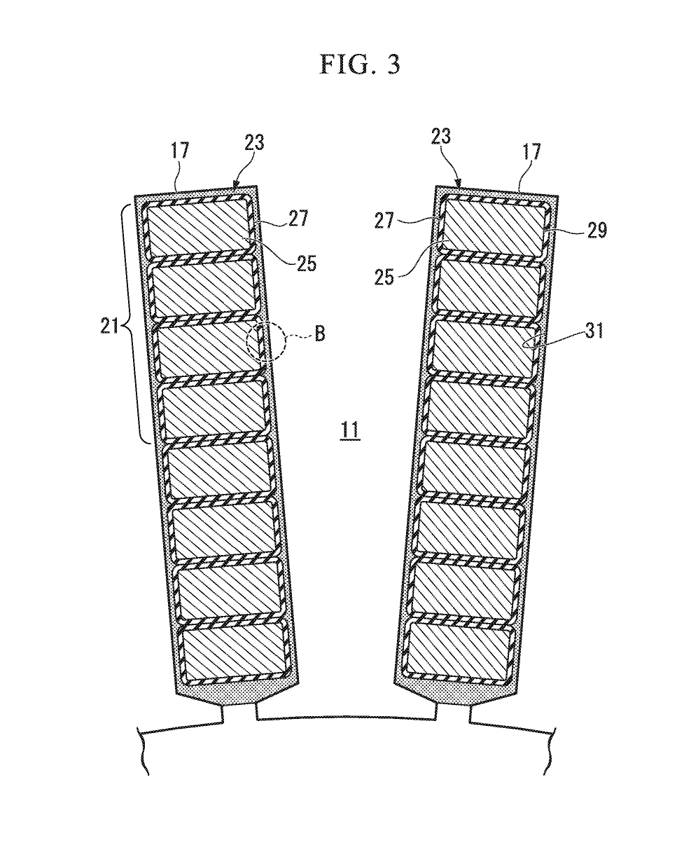

FIG. 3 is an enlarged view of a part A of FIG. 2. As illustrated in FIG. 3, each conductive wire 23 has a rectangular conductor 25 and a coating film 27. The rectangular conductor 25 is made of a conductive material. The rectangular conductor 25 constitutes the core wire of the conductive wire 23. The rectangular conductor 25 is formed in a U shape. The cross-section of the rectangular conductor 25 is formed in a rectangular shape.

The coating film 27 is coated on a surface 29 of the rectangular conductor 25. The coating film 27 is formed of, for example, a resin layer such as an enamel layer.

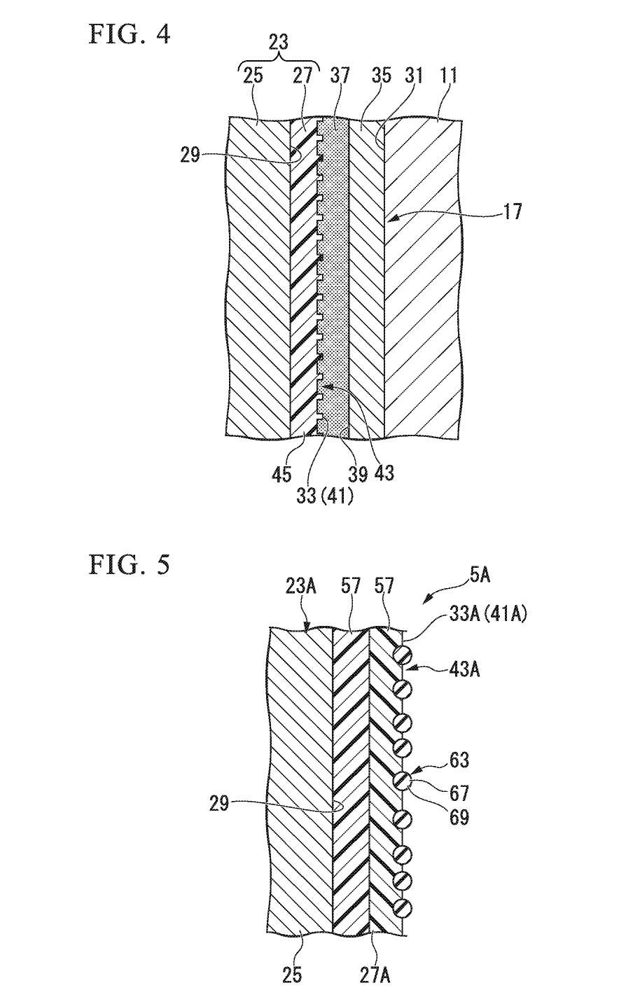

FIG. 4 is an enlarged view of a part B of FIG. 3.

As illustrated in FIG. 4, an insulating paper 35 is disposed in close contact with the inner surface 31 of the slot 17. A varnish 37 is filled between a surface 33 of the coating film 27 and a surface 39 of the insulating paper 35. As a result, the varnish 37 is filled between the surface 33 of the coating film 27 and the inner surface 31 of the slot 17. The varnish 37 fixes the surface 33 of the coating film 27 and the inner surface 31 of the slot 17.

The coating film 27 is provided with a recessed part-forming region 41 in which a recessed part 43 is formed in the surface 33.

The varnish 37 enters the recessed part 43. A depth of the recessed part 43 is set to 1 μm or more and 10 μm or less.

The recessed part 43 of the recessed part-forming region 41 is formed by processing the coating film 27 with sand blasting. The recessed part 43 is formed in the following order, for example.

(1) A portion of the conductive wire 23 in which the recessed part 43 is not formed is covered with a masking sheet.

(2) An abrasive is sprayed on the conductive wire 23, and a portion not covered with the masking sheet is abraded to form the recessed part 43 (recessed part-forming region 41).

(3) The masking sheet is removed.

In the stator 5 of the first embodiment, the recessed part-forming region 41 is provided in the surface 33 of the coating film 27 of the conductive wire 23. Since this increases a surface area of the coating film 27, the adhesiveness of the varnish 37 to the surface 33 of the coating film 27 is improved. Furthermore, since the varnish 37 enters the recessed part 43, an anchoring effect can be obtained. Therefore, the varnish 37 can reliably fix the surface 33 of the coating film 27 and the inner surface 31 of the slot 17. Therefore, in the stator 5 of the first embodiment, it is possible to reliably fix the conductive wire 23 to the stator core 11, merely by providing the recessed part-forming region 41 in the surface 33 of the coating film 27 of the conductive wire 23. Therefore, the stator 5 of the first embodiment can easily and reliably fix the conductive wire 23 to the stator core 11.

Further, in the stator 5 of the first embodiment, since the surface area of the coating film 27 is increased by providing the recessed part-forming region 41 in the coating film 27 of the conductive wire 23, the heat exchange area of the coating film 27 increases. Therefore, the stator 5 of the first embodiment can improve the cooling performance of the conductive wire 23 when the conductive wire 23 is cooled, for example, using a refrigerant.

Further, in the stator 5 of the first embodiment, the depth of the recessed part 43 was set to 1 μm or more and 10 μm or less. As a result, since the varnish 37 can sufficiently enter the recessed part 43, it is possible to further reliably fix the surface 33 of the coating film 27 and the inner surface 31 of the slot 17. Therefore, the stator 5 of the first embodiment can further reliably fix the conductive wire 23 to the stator core 11. Further, by setting the depth of the recessed part 43 to 1 μm or more and 10 μm or less, it is possible to suppress a decrease in the partial discharge starting voltage and to prevent partial discharge.

Further, in the stator 5 of the first embodiment, the recessed part 43 of the recessed part-forming region 41 is formed by processing with sand blasting. As a result, it is possible to easily form the recessed part 43. Therefore, the varnish 37 can more easily fix the surface 33 of the coating film 27 and the inner surface 31 of the slot 17. Further, depending on the particle diameter used in the sand blasting, the size of the recessed part 43 can be easily adjusted to form the recessed part 43. Therefore, the stator 5 of the first embodiment can easily and reliably fix the conductive wire 23 to the stator core 11.

Further, since the electric motor 1 of the first embodiment includes the aforementioned stator 5 that can easily and reliably fix the conductive wire 23 to the stator core 11, the electric motor 1 having high durability and high performance is preferably provided.

### Second Embodiment

Next, the stator of the second embodiment will be described with reference to FIG. 5. In the following description, the detailed description of the same configuration as in the first embodiment will be omitted.

FIG. 5 is a cross-sectional view of a conductive wire of a stator according to a second embodiment of the present invention.

The conductive wire 23A mounted in the stator 5A has a rectangular conductor 25 and a coating film 27A. The coating film 27A is coated on the surface 29 of the rectangular conductor 25. The coating film 27A is formed by laminating a plurality of resin layers 57. The resin layer 57 is formed of a resin material such as polyimide or enamel. The resin layer 57 of the surface layer is formed by being coated on the surface of the lower resin layer 57 and dried and solidified.

In the surface 33A of the coating film 27A, a recessed part-forming region 41A is provided. A plurality of recessed part-forming members 63 are provided in the recessed part-forming region 41A. Part of the plurality of recessed part-forming members 63 is embedded in the resin layer 57 of the surface layer of the coating film 27A. As a result, a recessed part 43A is formed between the plurality of recessed part-forming members 63 in the recessed part-forming region 41A. A depth of the recessed part 43A is set to 1 μm or more and 10 μm or less.

As the recessed part-forming member 63, for example, so-called microcapsules are adopted. The recessed part-forming member 63 is formed in a particulate and solid state. An outer shell 67 of the recessed part-forming member 63 is formed of, for example, a silicone resin material. For example, an acrylic resin material 69 is filled inside the recessed part-forming member 63. A method of installing the recessed part-forming member 63 will be described. The recessed part-forming member 63 is added to a resin coating material (for example, polyimide resin coating material) applied as the resin layer 57 of the surface layer. The resin coating material of the surface layer, to which the recessed part-forming member 63 is added, is dried and solidified to be the resin layer 57 of the surface layer. As a result, the recessed part-forming member 63 is installed in a state in which part of the recessed part-forming member 63 protrudes from the resin layer 57 of the surface layer.

In the stator 5A of the second embodiment, a plurality of recessed part-forming members 63 are provided in the recessed part-forming region 41A, and a recessed part 43A is formed between the plurality of recessed part-forming members 63. Thus, it is possible to easily adjust the size of the recessed part 43A and form the recessed part 43A, merely by adjusting the ratio between the materials for forming the coating film 27A and the recessed part-forming member 63, the size of the recessed part-forming member 63 and the like. Therefore, the varnish 37 (see FIG. 4) can more easily fix the surface 33A of the coating film 27A and the inner surface 31 of the slot 17. Therefore, the stator 5A of the second embodiment can easily and reliably fix the conductive wire 23A to the stator core 11.

Further, in the stator 5A of the second embodiment, each of the plurality of recessed part-forming members 63 is formed in a particle shape. Thus, it is possible to easily to adjust the size of the recessed part 43A and form the recessed part 43A, by merely adjusting the ratio between the materials for forming the coating film 27A and the recessed part-forming member 63 or the particle size of the recessed part-forming member 63. Therefore, the varnish 37 can more easily fix the surface 33A of the coating film 27A and the inner surface 31 of the slot 17 (see FIG. 4). Therefore, the stator 5A of the second embodiment can easily and reliably fix the conductive wire 23A to the stator core 11 (see FIG. 4).

Further, since the silicone resin has good affinity with the varnish 37, the adhesion of the varnish 37 to the recessed part-forming member 63 (that is, the recessed part 43A) increases. Therefore, the anchoring effect of the varnish 37 on the recessed part 43A is further enhanced. Therefore, the varnish 37 can reliably fix the surface 33A of the coating film 27A and the inner surface 31 of the slot 17. Therefore, the stator 5A of the second embodiment can further reliably fix the conductive wire 23A to the stator core 11.

### Modified Example of Second Embodiment

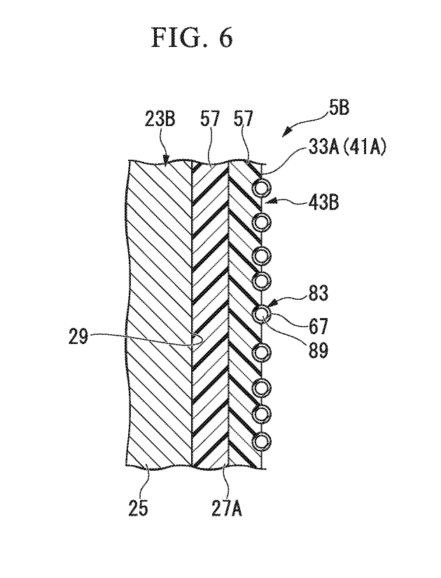

Next, a stator of a modified example of the second embodiment will be described referring to FIG. 6.

FIG. 6 is a cross-sectional view of a conductive wire of a stator according to the modified example of the second embodiment of the present invention.

A conductive wire 23B attached to the stator 5B according to the modified example of the second embodiment has a rectangular conductor 25 and a coating film 27A.

A recessed part-forming region 41A is provided in the surface 33A of the coating film 27A. A plurality of recessed part-forming members 83 are provided in the recessed part-forming region 41A. Part of the plurality of recessed part-forming members 83 is embedded in the resin layer 57 of the surface layer of the coating film 27A. As a result, a recessed part 43B is formed between the plurality of recessed part-forming members 83 in the recessed part-forming region 41A. The depth of the recessed part 43B is set to 1 μm or more and 10 μm or less.

The recessed part-forming member 83 is formed in a particulate and hollow shape. That is, an interior 89 of the recessed part-forming member 83 is a space. The hollow recessed part-forming member 83 is formed, for example, by applying heat to the recessed part-forming member 63 (see FIG. 5) of the second embodiment and vaporizing the acrylic resin material 69 (see FIG. 5) inside.

In the stator 5B according to the modified example of the second embodiment, the recessed part-forming member 83 is formed in a particulate and hollow shape. As a result, it is possible to easily form the recessed part 43B by suppressing an increase in the dielectric constant. Therefore, the varnish 37 (see FIG. 4) can suppress partial discharge and easily fix the surface 33A of the coating film 27A and the inner surface 31 (see FIG. 4) of the slot 17. Therefore, the stator 5B of the modified example of the second embodiment can suppress partial discharge and easily and reliably fix the conductive wire 23B to the stator core 11 (see FIG. 4).

It should be noted that the present invention is not limited to the above-described embodiments described with reference to the drawings, and various modifications are conceivable in the technical scope thereof.

For example, in each of the above-described embodiments, the insulating paper 35 is interposed between the inner surface 31 of the slot 17 and the varnish 37, but the insulating paper 35 may not necessarily be interposed.

Further, in the second embodiment and the modified example of the second embodiment, so-called microcapsules are used as the recessed part-forming members 63 and 83, but other particulate members may be used.

In addition, it is possible to appropriately replace the constituent elements in the above-described embodiments with well-known constituent elements within the scope that does not depart from the spirit of the present invention.

What is claimed is:

1. A stator comprising a stator core provided with a slot, and a conductive wire disposed in the slot,
wherein the conductive wire has a rectangular conductor, and a coating film coated on a surface of the rectangular conductor,
a varnish configured to fix a surface of the coating film and an inner surface of the slot is filled between the surface of the coating film and the inner surface of the slot, and
the surface of the coating is provided with a recessed part-forming region in which a recessed part into which the varnish enters is formed.

2. The stator according to claim 1, wherein a depth of the recessed part is set to 1 μm or more and 10 μm or less.

3. The stator according to claim 1, wherein the recessed part of the recessed part-forming region is formed by being processed with sand blasting.

4. The stator according to claim 1, wherein a plurality of recessed part-forming members are provided in the recessed part-forming region, and
the recessed part is formed between the plurality of recessed part-forming members.

5. The stator according to claim 4, wherein the plurality of recessed part-forming members are formed in a particle shape.

6. The stator according to claim 5, wherein the plurality of recessed part-forming members are hollow.

7. A rotary electric machine comprising the stator according to claim 1.
